(19) United States
(12) Patent Application Publication
(10) Pub. No.: US 2013/0109044 A1
(43) Pub. Date: May 2, 2013

(54) QUANTIFICATION METHOD FOR TOTAL AMOUNT OF MICROALGAL LIPIDS BY NEAR-INFRARED RAMAN SPECTROMETRY

(71) Applicants: Hsiang-Yu WANG, Tainan City (TW); Tsung-Hua Lee, Tainan City (TW); Jo-Shu Chang, Tainan City (TW)

(72) Inventors: Hsiang-Yu WANG, Tainan City (TW); Tsung-Hua Lee, Tainan City (TW); Jo-Shu Chang, Tainan City (TW)

(21) Appl. No.: 13/494,122

(22) Filed: Jun. 12, 2012

(30) Foreign Application Priority Data
Oct. 27, 2011 (TW) 100139131

(51) Int. Cl. G01N 21/65

(52) U.S. Cl. 435/29

(57) ABSTRACT

A quantification method for a total amount of microalgal lipids by near-infrared Raman spectrometry is disclosed, which includes the following steps: providing a microalgae sample and a substrate of which a surface is covered by a metal layer; applying the microalgae sample on the metal layer of the substrate; supplying a laser light in a wavelength of near-infrared light by which the microalgae sample is excited; recording Raman signals of the microalgae sample to form a Raman spectrum; and converting intensity of lipid signals in the Raman spectrum into a total amount of microalgal lipids in the microalgae sample according to a calibration curve.

### CROSS REFERENCE TO RELATED APPLICATION

This application claims the benefits of the Taiwan Patent Application Serial Number 100139131 filed on Oct. 27, 2011, the subject matter of which is incorporated herein by reference.

### BACKGROUND OF THE INVENTION

1. Field of the Invention

The present invention relates to a quantification method for total amount of microalgal lipids and, more particularly, to a quantification method for total amount of microalgal lipids by near-infrared Raman spectrometry.

2. Description of Related Art

Not only microalgae, but most biological samples contain water molecules. Frequently, the water molecules in biological samples must be removed before analysis can be performed in some common instruments, for example, FT-IR. However, it requires considerable amount of time and labor to remove water and the analysis cannot be performed in a timely manner.

The conventional methods for quantifying microalgal lipids are gravimetric method and fluorescence spectroscopy. However, there are many limitations in these two methods. With regard to the gravimetric method, the water contained in the biological sample has to be removed, cell membrane thereof is destroyed, and microalgal lipids are extracted, purified, and weighted. Furthermore, a large amount of microalgae sample has to be used to obtain a pre-determined amount of microalgal lipids. With regard to the fluorescence spectroscopy, microalgae species, pretreatment durations, reagent concentrations and other experimental conditions may affect the fluorescence intensity. Hence, each sample has to be calibrated, and then quantified with a calibration curve. Thus, cost in time and labor are huge In addition, most of the quantification methods are invasive and microalgae cells lost their viability after the examination; therefore, they cannot be saved for further incubation.

Therefore, it is desirable to provide a rapid and noninvasive quantification method for microalgal lipids. Hence, the researchers can monitor microalgae contents in a timely manner and control the incubation conditions according to the real-time information. This technique is beneficial for biofuel production using microalgae or other industrial or academic applications related to cellular lipid contents.

### SUMMARY OF THE INVENTION

An object of the present invention is to provide a quantification method for a total amount of microalgal lipids by near-infrared Raman spectrometry, which can quantify a total lipid amount of microalgae without influences from water or diminishing cell viability. In addition, the quantification method of the present invention can monitor microalgae lipid contents in real-time, and therefore the condition of the culture of the microalgae can be modified in a timely manner.

To achieve the object, one aspect of the present invention is to provide a quantification method for a total amount of microalgal lipids by near-infrared Raman spectrometry, which comprises the following steps: providing a microalgae sample and a substrate, wherein a surface of the substrate is covered with a metal layer; applying the microalgae sample on the metal layer of the substrate; supplying a laser light with a wavelength beyond a near-infrared region to excite the microalgae sample; recording Raman signals of the microalgae sample to obtain a Raman spectrum; and converting intensity of lipid signals in the Raman spectrum into a total amount of microalgal lipids in the microalgae sample according to a calibration curve.

According to the aforementioned quantification method for a total amount of microalgal lipids by near-infrared Raman spectrometry of the present invention, the condition of the microalgae sample is not particularly limited, and the example of which can be a dried microalgae sample, a microalgae paste sample, or other types. The microalgae paste sample is a sample in which redundant water contained therein has been removed. For example, the microalgae paste sample is prepared by centrifuging microalgae solution at a predetermined rotation rate, centrifugal force and centrifugal time. A person skilled in the art can obtain the rotation rate, the centrifugal force and the centrifugal time based on the conventional knowledge, as long as the redundant water in the sample is removed. For example, the sample can be centrifuged at 10,000-20,000 rpm for 1-20 mins to obtain the microalgae paste sample. In addition, the dried microalgae sample is a sample in which all the water contained therein has been removed. A person skilled in the art can determine the drying method based on conventional knowledge. For example, the sample can be dried by freeze drying. In addition, the wavelength of the laser light can range from 750 nm to 3200 nm. Herein, the wavelength of the laser light can be determined by a person skilled in the art based on the power of the laser light. For example, the laser light is a 70 mW infrared light at a 785 nm wavelength.

According to the aforementioned quantification method for a total amount of microalgal lipids by near-infrared Raman spectrometry of the present invention, the algal type contained in the microalgae sample is not particularly limited. For example, the algae contained in the microalgae sample can belong to Chlorella, such as Chlorella vulgaris. Although the near-infrared Raman spectrum of the microalgae may differ with the algal type, the positions of the lipid signals are basically the same. Hence, a similar calibration curve can be applied to the quantification method for a total amount of microalgae, even though the types of the microalgae are different.

According to the aforementioned quantification method for a total amount of microalgal lipids by near-infrared Raman spectrometry of the present invention, the calibration curve is a lipid signal intensity—total lipid amount curve. The lipid signals are wave number shifts in a range from 800 cm⁻¹ to 3200 cm⁻¹ in the Raman spectrum. Regardless of the sample type, the lipid signals are preferably wave number shifts in a rage from 1400 cm⁻¹ to 1600 cm⁻¹, and from 2700 cm⁻¹ to 3100 cm⁻¹ in the Raman spectrum. The intensity of the lipid signal can be a peak intensity of a single wave number shift, or a total area under peaks of wave number shifts within a certain wavelength range. Both the lipid amount and the cell number in the microalgae sample influence the intensity of the lipid signals in Raman spectrum. Hence, the amount of microalgae cells in a sample has to be calibrated, for example, the optical density of a microalgae sample can be adjusted to a predetermined value or the cell density can be calculated using a hemocytometer. Since water does not cause significant influence on the signals of near-infrared Raman spectrometry, samples are not particularly limited to dried ones. Hence, the method of the present invention can be easily applied to examinations of biological samples other than microalgae. Additionally, wavelengths of incident lights beyond the near-infrared region and signal acquisitions obtained therefrom are not influenced by auto-fluorescence of the microalgae samples. Furthermore, not all materials can generate signals when excited by near-infrared light and the noises resulting from impurities can be reduced.

The scanning time of the aforementioned near-infrared Raman spectrometry is much shorter than that of other instruments. Furthermore, the examination can be accomplished by continuous scanning when the method of the present invention is used. Hence, the method of the present invention can apply to not only academic research but also industrial manufacturing. When the method of the present invention is used, real-time examinations of the total amount of microalgal lipids and compositions in microalgae samples can be accomplished and costs in time, labor, and sample amount can be reduced.

In conclusion, the method of the present invention can examine the total amount of microalgal lipids in microalgae samples with near-infrared Raman spectrometry in a timely manner. Additionally, the method of the present invention is a non-invasive optical examination; therefore, viability of biological cells can be maintained during or after the examination method of the present invention. Hence, it is possible to select microalgae with high activity for future cultures. Furthermore, the signals obtained by near-infrared Raman spectrometry can be applied to different microalgae species. Finally, the cost in time, labor, and instruments can be reduced when the present invention is used.

When the method of the present invention is performed, sample pre-treatment is simple. Hence, the method of the present invention is suitable for industrial processes. Additionally, the user interface of the near-infrared Raman spectrometry can be designed to be straightforward to shorten the training of operators. Furthermore, only a small amount of microalgae sample is required to generate signals with suitable signal to noise ratio for accurate detection.

Other objects, advantages, and novel features of the invention will become more apparent from the following detailed descriptions when taken in conjunction with the accompanying drawings.

### BRIEF DESCRIPTION OF THE DRAWINGS

FIG. 1 is a near-infrared Raman spectrum of dried Chlorella vulgaris samples according to the Embodiments 1-4 of the present invention;

FIG. 2 is a calibration curve of a total amount of microalgal lipids in dried Chlorella vulgaris samples according to the Embodiments 1-4 of the present invention;

FIG. 3 shows the relation between wave number shifts and signal intensities of three samples taken at the same time;

FIG. 4 is a near-infrared. Raman spectrum of a dried Chlorella vulgaris sample according to Embodiment 4 and a Chlorella vulgaris wet paste sample according to Embodiment 11 of the present invention;

FIG. 5 is a calibration curve of the total amount of microalgal lipids in Chlorella vulgaris wet paste samples according to Embodiments 5-10 of the present invention; and

FIG. 6 shows the relation between peak intensities of near-infrared Raman spectra and microalgae amount.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Preparation Example 1

### Microalgae Culture

Chlorella vulgaris was cultured in basal medium containing a limited amount of nitrate and aerated with 0.2 vvm (gas volume/culture volume/min) 2-5% carbon oxide. After the culture reached a stationary state, the basal medium was then further changed into a nitrogen-deficient medium. This shortage in the nitrogen source induced Chlorella vulgaris to accumulate cellular lipids.

### Lipid Quantification by Gravimetric Method

Chlorella vulgaris with accumulated lipids of Preparation example 1 were examined with a wavelength of 685 nm to obtain an optical density. Then, the optical density was adjusted into a predetermined value having a range of 4.3 to 4.6. 200-500 mL of microalgae suspension was centrifuged at 12,000-15,000 rpm for a predetermined time, such as 3-10 mins, to remove water. Then, the sample was treated by a freeze-drying process to obtain a lyophilized powder sample.

The dehydrated lyophilized powder sample was then immersed into organic solvents to extract microalgae lipids. The residual component was weighed as a total amount of microalgae lipids in the microalgae sample. The obtained total amount of microalgae lipids was used as a reference for the following Embodiments 1-5 performed by near-infrared Raman spectrometry.

### Embodiments 1-4

### Lipid Quantification on Lyophilized Sample by Near-Infrared Raman Spectrometry

Chlorella vulgaris with accumulated lipids of Preparation example 1 were examined by the gravimetric method to obtain four microalgae samples used in the present embodiments, which respectively contained 5 wt % (Embodiment 1), 15 wt % (Embodiment 2), 30 wt % (Embodiment 3) and 65 wt % (Embodiment 4) of microalgal lipids based on the dried weight of microalgae.

These four microalgae samples were examined with a wavelength of 685 nm by use of a differential spectrometer to obtain optical densities. Then, the optical densities were adjusted into predetermined optical densities having a range of 4.3 to 4.6. Next, 0.5-2 mL of microalgae suspensions were centrifuged at 12,000-15,000 rpm for a predetermined time, such as 3-10 mins, to remove water. Then, the samples were treated with a freeze-drying process to obtain lyophilized powder samples.

A glass slide was coated with an Au film (about 150-250 Å) by an E-bream evaporator, and the obtained glass slide was used as a substrate for lipid quantification by near-infrared Raman spectrometry. Fixed volumes of lyophilized microalgae powder samples were placed on the glass slide coated with the Au film to perform the following lipid quantification by near-infrared Raman spectrometry. Herein, near-infrared light source was provided to excite the microalgae samples, and a deep-cooled detector was used to capture the Raman scattering signals.

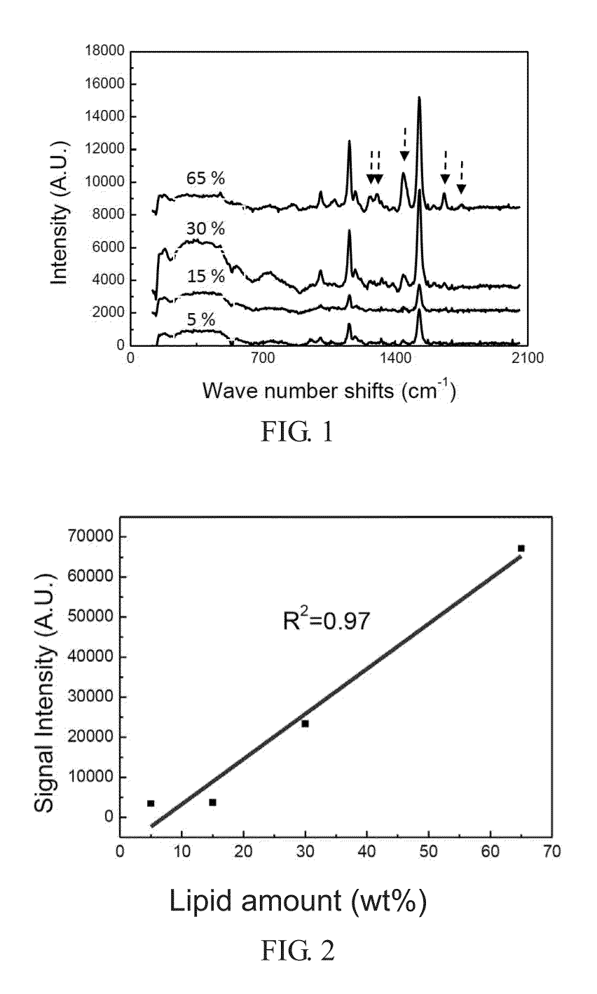

The results are shown in FIG. 1. The dried microalgae samples produced eight main peaks in wave number shifts of 200-1800 cm⁻¹, and five peaks of them (1266 cm⁻¹, 1302 cm⁻¹, 1440 cm⁻¹, 1660 cm⁻¹, and 1749 cm⁻¹) were contributed by lipids, as indicated in the following Table 1.

TABLE 1
Lipids

| Raman shift | |
|---|---|
| (cm⁻¹) | Assignment |
| 3008 | υₐₛ(═C—H) |
| 2970 | υₐₛ(C—H₃) |
| 2940 | υₐₛ(C—H₂) |
| 2885 | υₛ(C—H₃) |
| 2850 | υₛ(C—H₂) |
| 1750 | υ(C═O) |
| 1660 | υ(═C—H)cis |
| 1444 | δ(C—H₂) |
| 1300 | τᵢₚ(C—H₂) |
| 1266 | δᵢₚ(═C—H)cis |

(Reference: Schulz & Baranska, 2007; Wood et al., 2005; and Wu et al., 2011)

The Raman shifts caused by lipids represented different intermolecular vibration modes: cis=C—H in plane deformation (1266 cm⁻¹), CH₂ twisting motion (1302 cm⁻¹), CH₂ scissoring deformation (1440 cm⁻¹), and cis C═C stretching (1660 cm⁻¹). The shifts at 1440 cm⁻¹ and 1660 cm⁻¹ were present in the dried microalgae samples containing 5-65 wt % of microalgal lipids of Embodiments 1-4. However, the shifts at 1266 cm⁻¹, 1302 cm⁻¹, and 1749 cm⁻¹ were too weak to be observed when the microalgal lipids contained in the sample were lower than 15 wt %. In addition, the shift at 1660 cm⁻¹ was contributed by double bounds, so the shift at 1440 cm⁻¹ was chosen to serve as a standard for the total amount of lipids.

Furthermore, a calibration curve shown in FIG. 2 was plotted, wherein the X-axis represented total amounts of lipids contained in dried microalgae samples of Embodiments 1-4, and the Y-axis represented signal intensities of Raman shifts at 1440 cm⁻¹. As shown in FIG. 2, signal intensities of Raman shifts at 1440 cm⁻¹ were highly related to the total amounts of lipids contained in dried microalgae samples (correlation coefficient R²=0.97). These results show that significant Raman shifts on the near-infrared Raman spectrum, such as the Raman shift at 1440 cm⁻¹, can be used to quantify the total amounts of lipids contained in microalgae powder samples.

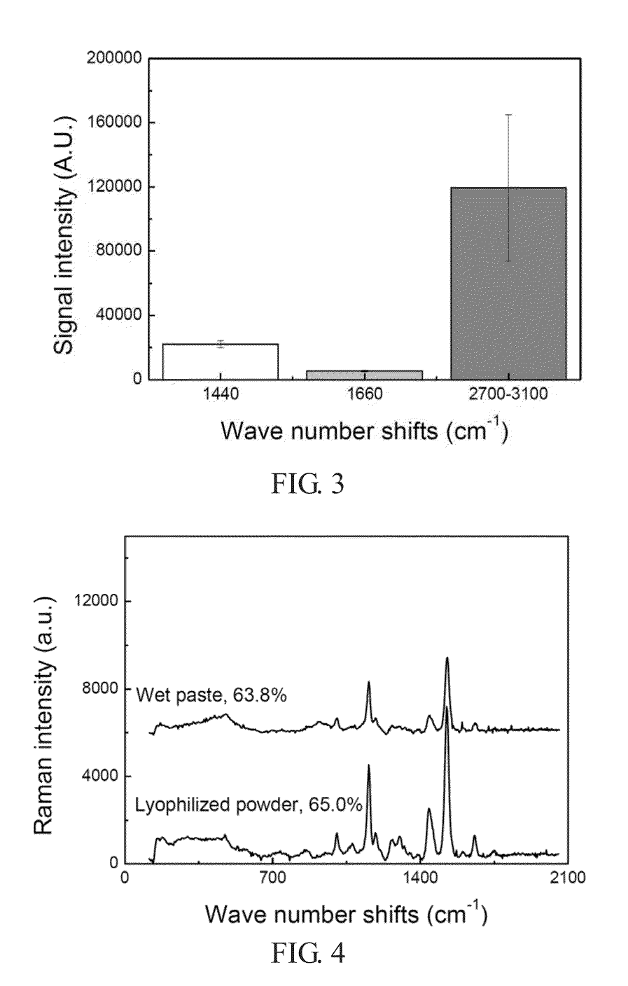

In addition, FIG. 3 shows a relation between wave number shifts and signal intensities of three samples taken at the same time and data for each sample was obtained by three examinations. All the signal intensities were consistent with each other, and these results indicate that the method of the present invention has excellent reproducibility, as shown in FIG. 3.

### Embodiments 5-11

### Lipid Quantification on Wet Paste Sample by Near-Infrared Raman Spectrometry

Chlorella vulgaris with accumulated lipids of Preparation example 1 were examined by the gravimetric method to obtain seven microalgae samples used in the present embodiments, which respectively contained 14 wt % (Embodiment 5), 15 wt % (Embodiment 6), 25 wt % (Embodiment 7), 34 wt % (Embodiment 8), 38 wt % (Embodiment 9), 45 wt % (Embodiment 10), and 63.8 wt % (Embodiment 11) of microalgal lipids based on the dried weight of microalgae.

These seven microalgae samples were examined with a wavelength of 685 nm by use of a differential spectrometer to obtain optical densities. Then, the optical densities were adjusted to predetermined optical densities having a range of 4.3 to 4.6. Next, 0.5-2 mL of microalgae suspensions were centrifuged at 12,000-15,000 rpm for a predetermined time, such as 3-10 mins, to remove water. Thus, wet paste samples were obtained.

A glass slide was coated with an Au film (about 150-250 Å) by an E-bream evaporator and the obtained glass slide was used as a substrate for lipid quantification by near-infrared Raman spectrometry. The fixed volume microalgae paste samples were placed on the glass slide coated with Au film to perform the following lipid quantification by near-infrared Raman spectrometry. Herein, a near-infrared light source was provided to excite the microalgae samples, and a deep-cooled detector was used to capture the Raman scattering signals.

The results are shown in FIG. 4, which is near-infrared Raman spectra of a lyophilized (dried) Chlorella vulgaris sample according to Embodiment 4 and a Chlorella vulgaris wet paste sample according to Embodiment 11 of the present invention. As shown in FIG. 4, even though the total amount of lipids contained in the wet paste microalgae sample of Embodiment 11 was comparable to Embodiment 4, the signal intensities of Raman shifts at 1266 cm⁻¹, 1302 cm⁻¹ and 1749 cm⁻¹ thereof are lower than that of Embodiment 4.

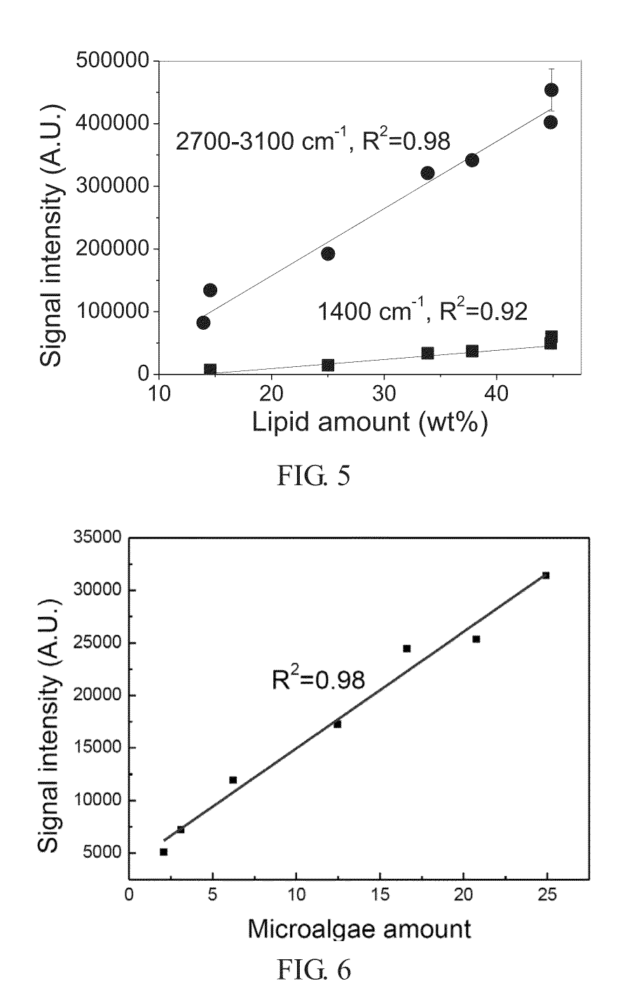

The calibration curve for Embodiments 5-10 was also plotted, wherein the X-axis represents total amounts of lipids contained in microalgae samples of Embodiments 5-10, and the Y-axis represents the signal intensities of Raman shifts at 1440 cm⁻¹ and from 2700 cm⁻¹ to 3100 cm⁻¹. As shown in FIG. 5, the total intensities of Raman shifts in this range were highly correlated with the total amounts of lipids in microalgae samples (correlation coefficient R²>0.92). These results indicate that specific Raman shifts on the near-infrared Raman spectrum, such as the total intensities of the Raman shifts from 1.400 cm⁻¹, or 2700 cm⁻¹ to 3100 cm⁻¹, are still suitable for lipid quantification of samples containing water.

FIG. 6 shows a relation between peak intensities (i.e. total intensities of Raman shifts from 2700 cm⁻¹ to 3100 cm⁻¹) and microalgae amount, wherein the microalgae amounts in wet paste samples (O.D.×mL) were calculated with optical densities at 685 nm. As shown in FIG. 6, the signal intensities increased as the cell number of microalgae increased. Hence, in spite of the cellular status variations during the nitrogen depletion period, the relationship between the total amount of lipids and signal intensities remained linear when the samples were adjusted to the same optical densities. Hence, the optical densities of samples may be used as references for quantification of microalgal lipids, instead of a standard peak within the Raman spectrum.

Although the present invention has been explained in relation to its preferred embodiment, it is to be understood that many other possible modifications and variations can be made without departing from the spirit and scope of the invention as hereinafter claimed.

What is claimed is:

1. A quantification method for a total amount of microalgal lipids near-infrared Raman spectrometry, comprising the following steps:
providing a microalgae sample and a substrate, wherein a surface of the substrate is covered with a metal layer;
applying the microalgae sample on the metal layer of the substrate;
supplying a laser light with a wavelength beyond a near-infrared region to excite the microalgae sample;
recording Raman signals of the microalgae sample to obtain a Raman spectrum; and
converting intensity of lipid signals in the Raman spectrum into total amount of microalgal lipids in the microalgae sample according to a calibration curve.

2. The quantification method for a total amount of microalgal lipids by near-infrared Raman spectrometry as claimed in claim 1, wherein the microalgae sample is a dried microalgae sample, a microalgae paste sample, or other types.

3. The quantification method for a total amount of microalgal lipids by near-infrared Raman spectrometry as claimed in claim 2, wherein the microalgae paste sample is prepared by treating microalgae with a centrifugal force.

4. The quantification method for a total amount of microalgal lipids by near-infrared Raman spectrometry as claimed in claim 1, wherein the laser light has a wavelength from 750 nm to 3200 nm.

5. The quantification method for a total amount of microalgal lipids by near-infrared Raman spectrometry as claimed in claim 1, wherein algae contained in the microalgae sample belong to Chlorella.

6. The quantification method for a total amount of microalgal lipids by near-infrared Raman spectrometry as claimed in claim 5, wherein the algae are Chlorella vulgaris.

7. The quantification method for a total amount of microalgal lipids by near-infrared Raman spectrometry as claimed in claim 1, wherein the calibration curve represents a relationship between lipid signal intensities and total lipid amounts.

8. The quantification method for a total amount of microalgal lipids by near-infrared Raman spectrometry as any one claimed in claims 1 to 7, wherein the lipid signals of the microalgae sample are wave number shifts in a range from 800 cm⁻¹ to 3200 cm⁻¹ in the Raman spectrum.

9. The quantification method for a total amount of microalgal lipids by near-infrared Raman spectrometry as claimed in claim 8, wherein the lipid signals of the microalgae sample are wave number shifts in a range from 1400 cm⁻¹ to 1600 cm⁻¹, and from 2700 cm⁻¹ to 3100 cm⁻¹ in the Raman spectrum.

10. The quantification method for a total amount of microalgal lipids by near-infrared Raman spectrometry as claimed in claim 8, wherein an optical density of the microalgae sample is used as a reference for calibrating the Raman spectrum.

11. The quantification method for a total amount of microalgal lipids by near-infrared Raman spectrometry as claimed in claim 9, wherein an optical density of the microalgae sample is used as a reference for calibrating the Raman spectrum.
